(19) United States
(12) Patent Application Publication
(10) Pub. No.: US 2019/0245409 A1
(43) Pub. Date: Aug. 8, 2019

(54) Electrical amplification systems through resonance

(71) Applicant: Andrew R. Alcon, Fort Worth, TX (US)

(72) Inventor: Andrew R. Alcon, Fort Worth, TX (US)

(73) Assignee: Vital Tech, LLC, Cheyenne, WY (US)

(21) Appl. No.: 16/350,749

(22) Filed: Dec. 31, 2018

Related U.S. Application Data
(60) Provisional application No. 62/709,944, filed on Feb. 6, 2018.

(51) Int. Cl. H02K 7/065; H02K 11/00; H02K 11/33

(52) U.S. Cl. CPC H02K 7/065; H02K 11/33; H02K 11/0094

(57) ABSTRACT

A device, method and process to induce and amplify electrical energy through resonance and vibration, the device producing voltage and current generation with amplification within electrical motors, primarily DC motors, by vibration of the motors, including the capability to tune and control the regulation of the output current and voltage by the addition of electrical components with predictable results.

### CROSS REFERENCE TO RELATED APPLICATIONS

Applicant claims the benefit of a U.S. Provisional Patent Application No. 62/709,944, filed on Feb. 6, 2018 by the same inventor.

### I. BACKGROUND OF INVENTION

### 1. Field of the Invention

A device, method and process produces electric current and voltage by the vibration of the electrical motors, including the capability to tune and control the output current and voltage by the addition of electrical components with predictable results.

### 2. Description of Prior Art

A preliminary review of prior art patents was conducted by the applicant which reveals prior art patents in a similar field or having similar use. However, the prior art inventions do not disclose the same or similar elements as the present device, method and process, nor do they present the material components in a manner contemplated or anticipated in the prior art. In fact, this concept and physical conversion disclosed within the device, method and process has never been successfully demonstrated in any prior art. Therefore, no relevant prior art reference is contained in this specification, other than the use of known electrical components which do not provide a similar or even remotely related predictable result.

### II. SUMMARY OF THE INVENTION

It has been discovered that DC motors, especially those having ferromagnetic elements, can utilize input of resonant vibrational power to produce electrical energy to operate the motor. The vibrational energy acts upon the motor to provide an electrical and mechanical output. Additionally, the resonant power to the motor not only provides a mechanical output from the motor, but also generates a supplemental electrical energy that can be cycled through the motor and used by an outside electrical load. The vibrational energy delivered to the DC motor is measured as a very high AC voltage with a frequency in the KHz range.

The use of diodes (to rectify the AC power to DC power), inductor coils (an electrical component comprising of a length of wire around a ferromagnetic core), capacitors (an electrical device having two conducting plate surfaces used to store charge on its plates that are separated by a dielectric insulator), and other system components are used to convert, control, and regulate the high frequency AC power produced by the resonant vibrations of the generator/motor into DC power to run the generator/motor and power the external load.

The present device, method, and process discloses the rectification of a high voltage AC output with a frequency in the KHz range on a DC generator/motor through the vibrational energy of the generator/motor itself. The vibrational energy can be delivered to the generator/motor by attaching a transducer or other means of vibrational energy directly to the generator/motor or to a fixture attached to the generator/motor. The generator/motor can either be resting on the fixture or otherwise attached to a fixture in a manner not foreseen or hereby discovered prior to the present invention. The conversion potential produces an exceptionally enhanced conversion differential, from other previously unknown means. Electro-vibrational energy is demonstrated and disclosed by using a tuned resonant transducer (or other means of vibrational energy) which is matched with the resonant frequency of the generator/motor housing. Secondaiy electrical components can be used to rectify, enhance, control, and regulate the power output of the system verses the vibrational amplitude input with predictable results. If the wrong electrical values are used with certain components, the results will be a decrease in output efficiency of the system or a complete nullification of its function. However using the same components within an optimal characteristic range will exponentially enhance the efficiency of the previously unknown and unproven electrical generation of the methods and processes.

### III. DESCRIPTION OF THE DRAWINGS

The following drawings are formal drawings submitted with this patent application.

FIG. 1 is a schematic drawing of a 100 watt @ 40 KHz driver board for our ultrasonic transducers used for our test system.

FIG. 2 is a first embodiment of a circuit diagram involving an electrical amplification system through resonance.

FIG. 3 is a second embodiment of a circuit diagram involving an electrical amplification system through resonance.

FIG. 4 is a third embodiment of a circuit diagram involving an electrical amplification system through resonance.

FIG. 5 is a drawing indicating a DC electrical generator/motor sitting on an upper surface of an elevated vibrational support platform, with a lower surface of the elevated vibrational support platform attaching a transducer which induces a controlled electro-mechanical vibrational force to the elevated vibrational support platform as involved in FIGS. 2-4.

FIG. 6 is a pictorial view of our dual wound/dual commutator armature for our permanent magnet DC generator/motor.

FIG. 7 is a schematic view of the dual wound generator/motor receiving power from the circuit board and battery and returning power back to the battery and circuit hoard.

FIG. 8 is a view of the transducer pair with their piezo elements arranged with their polarity opposite from one another to produce a push/pull configuration for the present invention.

FIG. 9 shows an attachment of the ultrasonic devices attached to the opposite ends of the generator/motor.

### IV. DESCRIPTION OF THE PREFERRED EMBODIMENT

### A. General Devices

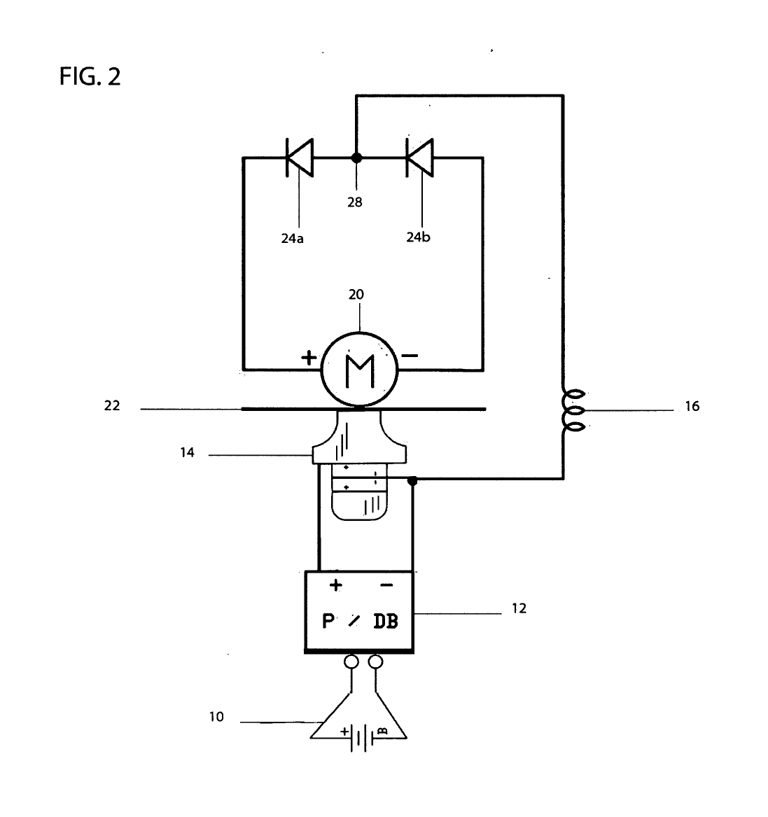

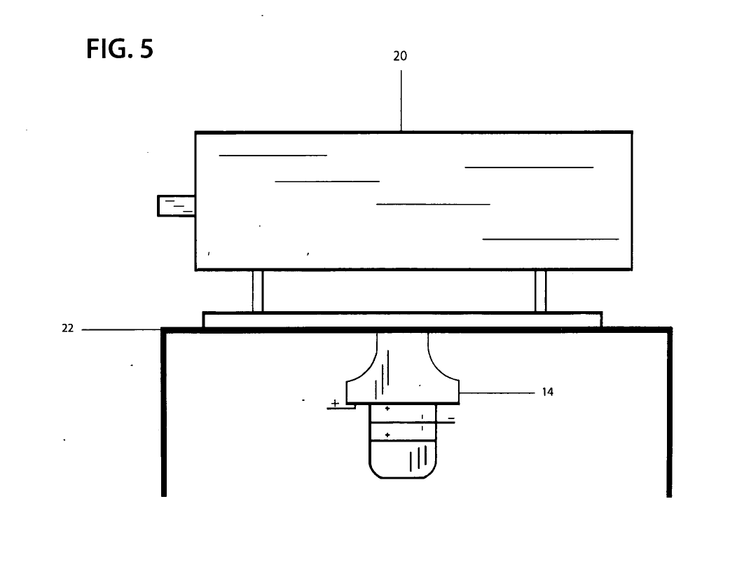

Several tested devices were operated using the basic concept of the present apparatus which produces electrical current and voltage by the electro-mechanical vibration of an electrical generator/motor, as indicated in FIGS. 2-5. Three separate demonstrable systems are shown in each of the three circuit diagrams identified in FIGS. 2-4. The initial operative elements comprise an elevated platform defining an upper surface, a lower surface and elevation legs to support the elevated platform above a level operating area, the upper surface upon which is located a ferromagnetic electrical generator/motor identified in FIG. 5.

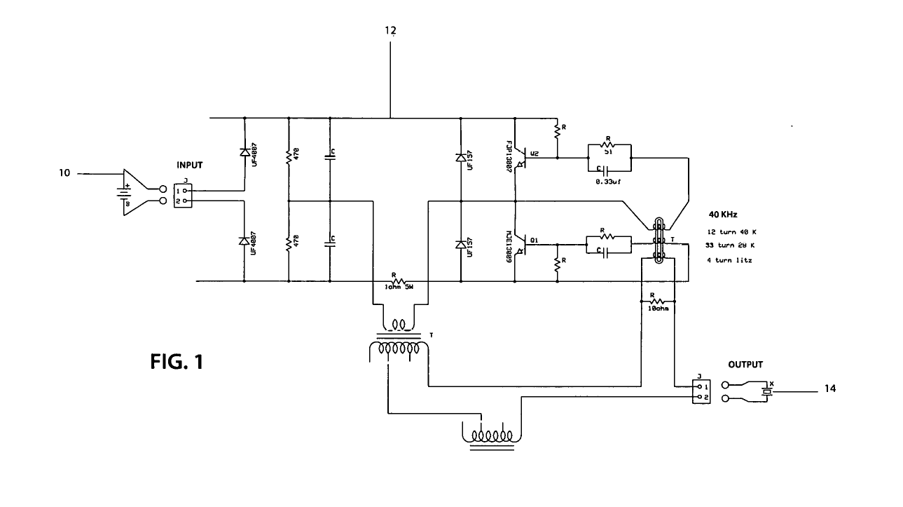

A transducer is provided, generally by securing it in a suitable manner to the lower surface of the platform, preferably centered below the base of the ferromagnetic electrical DC generator/motor which produces voltage and current. In experiments which provided the proven technology as exposed below, the tested transducer is identified as a 40 KHz @ 100 watt piezoelectric horn powered by a 40 KHZ @ 100 watt circuit board and matching power supply, all commonly indicated in FIGS. 1-4. The transducer is further identified as comprising an upper mass, a lower mass, and two piezo elements electrodes sandwiched between an upper and lower ceramic insulator of the piezoelectric element, with the positive electrode attaching generally to the upper portion of the piezoelectric element directly above the ceramic insulator, with the positive and negative electrodes further attaching to the circuit board operated by a power supply such as a battery or capacitor or other means. The diodes comprising the diode bridge are identified as ultra fast diodes rated at a high voltage.

Symbols within FIGS. 2-4 are derived from commonly known electrical symbols, with the exception being that the power supply and driver board is identified by “P/DB” indicating the power supply and driver board. Most generally the power supply provides an AC current and voltage to the transducer, which compels the transducer to produce a high frequency vibration or resonance within a known and controlled range suitable for the required performance of the operating systems. It is contemplated that other transducers or resonate producing electrical appliances may be used.

The general characteristics of the optimal transducer includes it being high performance, high mechanical Q-value, high conversion efficiency, large amplitude, with the piezoelectric elements being composed of ceramic materials with a good heat resistance (i.e. 100 watt@ 40 KHz). Stainless steel, bell metal or aluminum is also recommended for the upper and lower mass materials as well as the electrodes. The components noted above generally feature a compression bolt to secure the elements together as a unit, and an insulator is located between the compression bolt, the electrodes and the piezoelectric elements stacked upon one another. An upper surface of the upper mass is most often bonded to the lower surface of the disclosed elevated platform. The upper surface of the elevated platform receives transferred (high voltage) high frequency vibrational waves through the lower surfaces generated by the transducer. When the transducer commences operation, the resulting high voltage vibrational transferred energy causes the ferromagnetic electrical generator/motor to produce AC voltage which is rectified by the diodes to cause rotation of the generator/motor shaft as disclosed in FIGS. 2-4 & 7. Operation of the ferromagnetic electrical generator/motor is then used to provide mechanical power, electrical current and voltage by a circuit junction from the diode array connected to the generator/motor terminals to the transducer terminal between the piezo discs for supplemental continued operation of the involved system. The wire including the optional inductor must be connected in a circuit running from one of the diodes connected to a terminal of the generator to the insulated terminal between the piezo discs of the transducer for the system to work. If the incorrect electrical inductor coil is used, either nothing will happen or the output efficiency will be greatly diminished.

The system can operate without the inductor coil as our experimental data shows in the example section of this application. Therefore, some experimentation will be required to match and to either include or exclude the appropriate electrical inductor coil to optimize the power generation and movement of the ferromagnetic generator/motor using the correct and optimal vibrational output of the transducer. This could be done by use of a signal generator connected to the transducer and tuned to the proper electrical frequency with visual or metered monitoring system such as an oscilloscope.

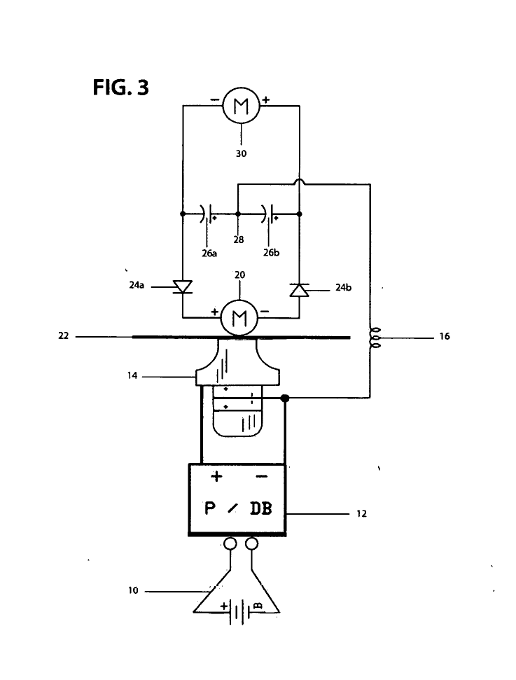

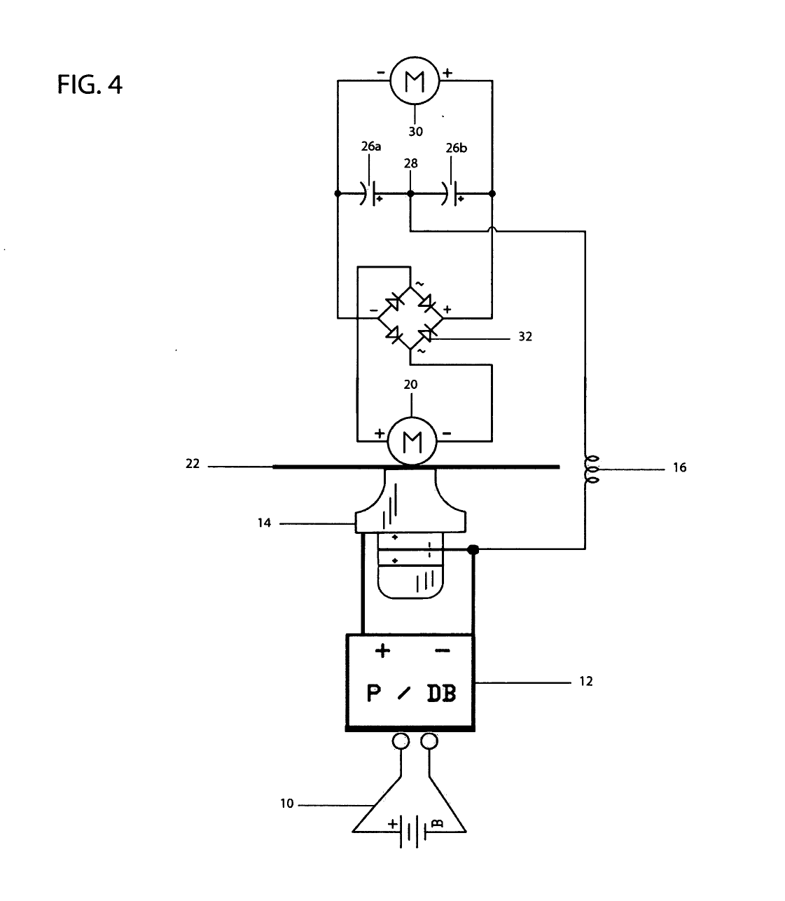

Therefore, the circuit diagrams will indicate this connection as being attached to the insulated terminal of the transducer in FIGS. 2-4. The capacitors used in FIGS. 3-4 are electrolytic capacitors which are rated for high voltage and relatively low micro-farads (400 volts @ 390 uF, et al) although other capacitors with various voltage and storage rating can be used depending upon the application.

In addition, the driver board is used which is illustrated by a schematic example seen in FIG. 1 which has the following essential components: a power cell, which could be a high voltage battery array or capacitor array connected in a series/parallel configuration to supply power to the board, an electrical inductor coil with a transformer, and transistors which are driven by the toroid transformer to provide a harmonic power supply to generate a resonance within the transducer providing vibrations to the platform and further transferring the specific optimal frequency to the motor casing of the ferromagnetic electrical generator/motor.

### B. Description of the Various Embodiments

### General Embodiment—Circuit Board Schematic

FIG. 1 shows a preferred embodiment of a schematic view of the circuit board which is driving our ultrasonic transducers commonly illustrated in FIGS. 1-9 below.

### First Embodiment—Single Commutator Generator with Single Transducer

FIG. 2 is identified as a first embodiment of an apparatus which produces electrical current and voltage by the vibration of an electrical generator/motor, as identified in the general section above. This device utilizes the single ferromagnetic electric permanent magnet DC generator/motor which produces electric current and voltage through a plurality of diodes which transfers the current and voltage through the diode bridge in the manner shown. Between the diodes comprising the diode bride is a wire which directs voltage back to the center electrode within the transducer to provide a power circuit between the generator/motor windings and the transducer. The ferromagnetic generator/motor of the first embodiment produces the voltage, generated solely by the electro-mechanical vibrational forces of the platform and also induces the spin of the generator/motor shaft within the ferromagnetic electrical generator/motor, thereby creating a mechanical force as well as a contemporary electrical current at a high voltage—much higher than the input voltage going into the transducer.

### Second Embodiment—Double Motor/Diodes

FIG. 3 is identified as a second embodiment of an apparatus which produces electrical current and voltage by the electro-mechanical vibration of a permanent magnet DC electrical generator/motor, as identified in the general section above. This device utilizes the two or more permanent magnet DC electric generator/motors that produce electric current and voltage through a series of diodes which transfer the current through the diode bridge in the manner shown. Also used is a pair of electrolytic capacitors located within the center of the diode bridge—one prior to and one subsequent to the intersecting wire connection through a circuit leading back to the electrode of the transducer, once again supplying supplemental electrical voltage to and from the transducer. Once again, the first ferromagnetic generator/motor produces high voltage output, generated solely by the electro-acoustical vibrational forces of the platform and also induces the spin of a motor shaft within the first ferromagnetic electrical generator/motor as it delivers power to an outside electrical load by rectifying the high frequency, high voltage AC power to DC power, thereby creating a mechanical force as well as a contemporary electrical current at a high voltage, much higher than the output voltage coming from the transducer. The power to the second ferromagnetic motor draws output power from the first ferromagnetic generator/motor causing the rotation of its motor shaft. The operational voltage and power of the second ferromagnetic motor is directly related to the voltage placed upon the capacitors from the resonant voltage produced from the first ferromagnetic generator/motor which is transferred to the capacitors through the diodes. It is further observed that placing a load on the spinning motor shaft of the second ferromagnetic motor increases the rotational RPM of the first ferromagnetic electrical generator/motor and that limiting the rotation of the shaft of the second ferromagnetic motor, the voltage generated by the first ferromagnetic electric generator/motor appears to be reflected back to itself. Thus far, the power enhancement is unmeasured and appears to have no limit potential when scaled up in size. This second embodiment is useful in operating one or more apparatuses which require a rotary shaft for mechanical power and also is useful in operating an apparatus which requires a charging voltage electrical output, including fuel cells, hydrogen cells and other appliances. It is contemplated that multiple motors could be operated within the system other than the two as shown.

### Third Embodiment—Double Motor/Bridge Rectifier

FIG. 4 is identified as a third embodiment of an apparatus which produces electrical current and voltage by the vibration of an electrical generator/motor, as identified in the general section above. This device utilizes the two or more ferromagnetic electric motors which produce current and voltage through a full wave bridge rectifier which transfers the current through the full wave bridge rectifier in the manner shown. Also used is a pair of electrolytic capacitors located within a wire bridge as shown between the two current wires further directed towards the second ferromagnetic electric motor, with dual electrolytic capacitors in the middle of the wire bridge—one electrolytic capacitor prior to and one electrolytic capacitor subsequent to an intersecting wire connection through the circuit leading back to the electrode of the transducer, once again supplying supplemental electrical power from the transducer. The first ferromagnetic generator/motor produces high voltage, generated solely by the electro-acoustical vibrational forces of the platform but does not induces the spin of a motor shaft within the first ferromagnetic electrical motor, only producing electrical current at a high voltage—much higher than the input voltage going into the transducer. The power to the second ferromagnetic motor further generates output power and possibly the rotation of a motor shaft providing a mechanical rotary force to operate a mechanical device or appliance.

This third embodiment in FIG. 4 is a solid state system using the full wave bridge rectifier across the terminals of the first ferromagnetic electric motor (generator/motor) instead of a string of diodes coming off the positive and negative terminals of the second embodiment. In view of the fact that a generator/motor will rotate in a pre-determined direction depending upon the direction of the presented diode array, if we placed a full wave bridge rectifier across the terminals, it would deliver 100% of the energy to the load, but it would no longer behave as a motor, due to the forces that act upon it causing rotation and it would equalize by tapping into both sides of the wave form. It should be anticipated that we would design a device with a resonant housing possessing a ferromagnetic field and a wire wound core similar to an armature of an electric motor but modified to produce very efficient high voltage electrical power through the electro-resonant vibration of the housing. This device would deliver high frequency AC voltage through the full wave bridge rectifier to power DC circuits.

### Fourth Embodiment—Dual Wound/Dual Commutator Rotor

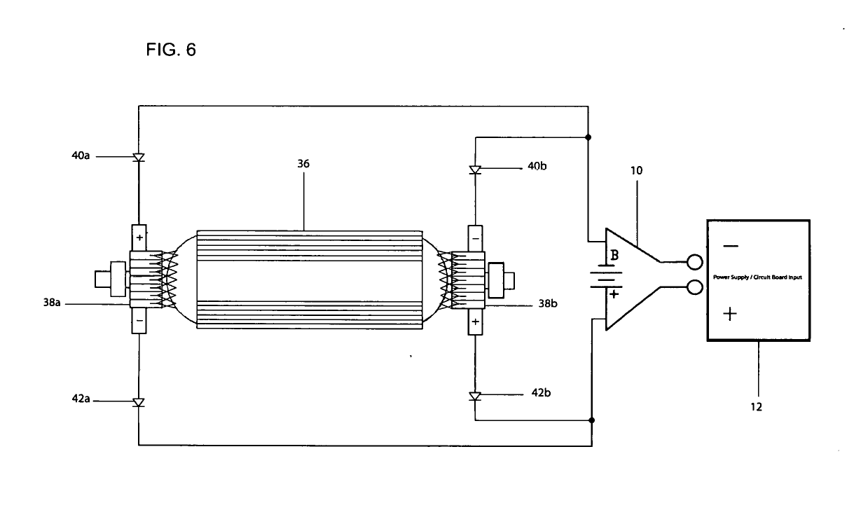

FIG. 6 discloses a dual wound/dual commutator armature for our permanent magnet DC generator/motor. The windings for each commutator are electrically isolated from the opposing commutator but they share the same magnetic field orientation through their respective armature windings. The diode configuration for the terminals of the opposing commutators supports the constant power for rotor rotation by being able to utilize the power of the high frequency AC voltage through rectifying both sides of the sine wave with the two commutators and their diode configuration. The diode configuration shown in FIG. 6 discloses the necessary configuration for delivering power to a load to support constant power and rotation of the rotor shaft.

### Fifth Embodiment—Dual Commutator DC Generator/Motor Power Loop to and from the Power Supply and Circuit Board

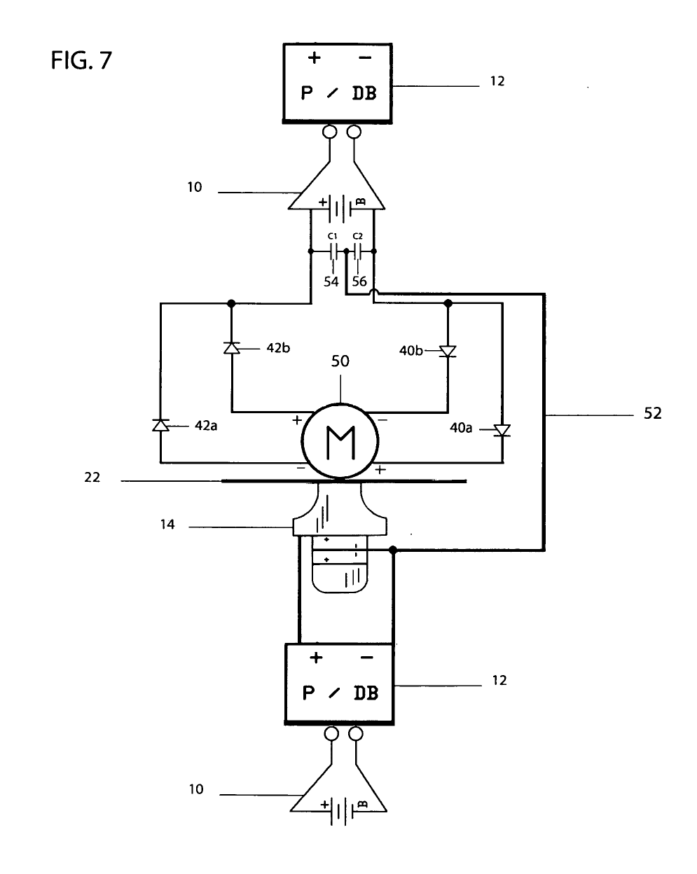

FIG. 7 shows an external schematic view of a dual commutator DC generator/motor. The schematic discloses the power loop circuit in which the dual commutator DC generator/motor receives electro-acoustical energy from the transducer which is driven by the power supply/driver board and how it returns power back to power supply/driver board.

### Sixth Embodiment—Two Transducers of Opposite Polarities Used for a Parallel Connection

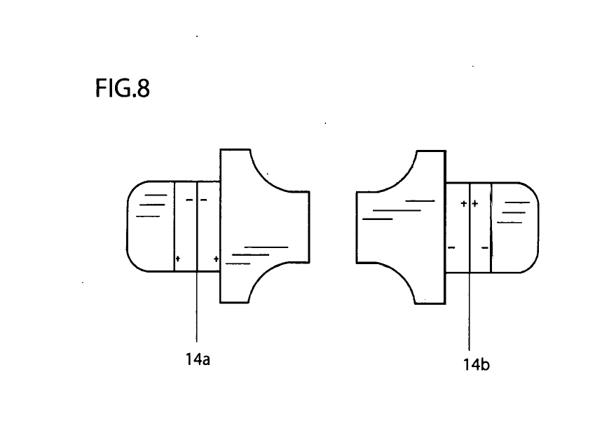

FIG. 8 shows two basically identical piezoelectric transducers assemblies shown in the standard construction form. Each transducer comprises of two piezoelectric discs clamped between a respective front driver and rear driver by a central bolt, not shown. It is noted that the piezoelectric discs of FIG. 8 are orientated with their sides reversed and flipped over with respect to one another. The orientation of each transducer is indicated by the plus and minus signs in FIG. 8. The terminals of the transducers are connected in parallel to a single circuit board and power supply. As a result, when positive voltage is supplied to the positive terminal in FIG. 14A and simultaneously to the negative terminal of 14B, the clamped assembly of FIG. 14A will expand at the same time that the clamped assembly of 14B will contract. When the voltage polarity is reversed, the reverse condition will take place with the opposing transducers. Therefore the transducers can be coupled to the opposite ends of the permanent magnet DC generator/motor in order to drive the motor at its resonant state. The vibration of the motor casing and armature will oscillate in phase in the same longitudinal direction while the transducers are vibrating at 180 degrees out of phase from one another. This effect is commonly known as a push-pull configuration. While one transducer is in the expansion mode, the other transducer is in the contraction mode. This transducer setup delivers superior electro-resonant power to the motor casing and the windings by coupling a transducer to each end of the motor casing and armature windings.

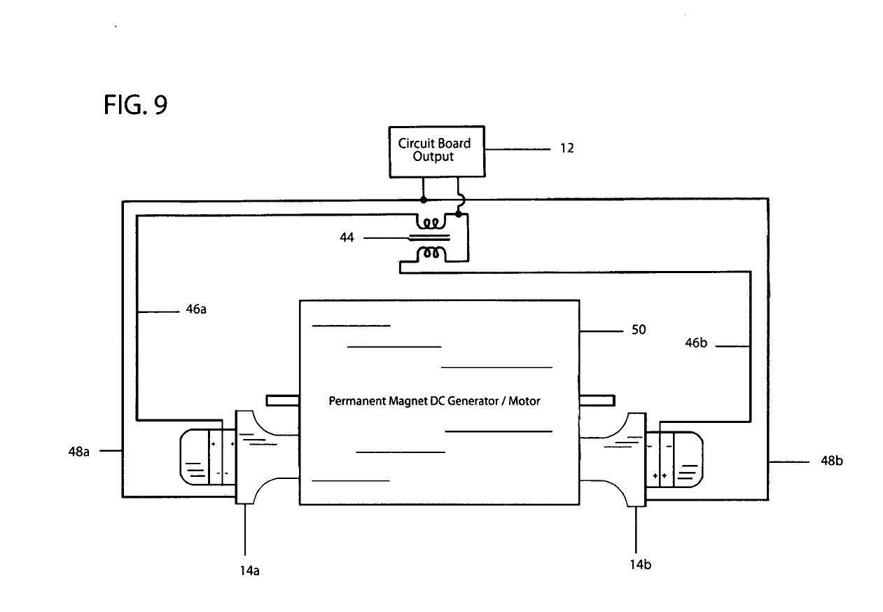

FIG. 9 shows an alternative embodiment of the present invention including a pair of ultrasonic transducers which are coupled to the opposite ends of the permanent magnet DC generator/motor.

### C. Performance and Utility

Early experiments observed by the applicant had been performed on vibrating ferrite core inductors over a number of years leading up to the present invention. The experiments included using DC power sources such as a battery, a DC generator, or a DC power supply. The experiments included using high speed transistors which were powered through a signal generator to deliver square wave pulses of DC power into numerous inductors of varying values from mill-henrys to micro-henrys. The pulses would produce an AC square wave signal in the inductor when the transistor was turned on and off as it delivered pulsed electrical power to the coil. The resonant frequency of each coil could be determined by measuring the DC voltage from two diodes attached on the wires on either end of the inductor. When the peak voltage was measured from the collapsed field of the inductors on the DC side of the diodes then the system would be in a state of tuned resonance. Each inductor value had a resonant frequency related to its value. The higher the inductor value was, the lower its resonant frequency would be. The lower the inductor value was, the higher its resonant frequency would be. It was observed that very high DC voltages could be obtained through the use of diodes on the inductors from the input of pulsed low DC voltages at the resonant frequency of the inductor coil. Other observations showed that the addition of a capacitor to collect the voltage from the diode would significantly increase the measured voltage even further. The capacitor would charge to a higher voltage than the output voltage measured at the diodes. It is believed that the resonant DC voltage from the diodes aided the capacitors to charge to a highcr DC voltage than the measured voltage from the diodes. Multiple experiments were performed to collect data. In one experiment, a 1.5 volt AA battery was used as a power source and a high speed transistor was placed in the circuit to turn on and off at a predetermined frequency which provided a pulsed voltage and current to the ferrite inductor coil. As the frequency was tuned to the resonance of the coil, the measured voltage on the DC side of the diode would increase and peak at the resonance of the coil. The tuned voltage measured above 250 volts on the DC side of the diodes from 1.5 volts of input power into the inductor coil. When we attached a 0.015 mfd capacitor to the DC side of the diode, the voltage measured in excess of 500 volts from the resonant coil. We performed another experiment in which a DC power supply was used as a power source to send pulses through a transistor into a 30 mH inductor at a predetermined frequency and voltage. We used a diode connected to the inductor to charge a 390 mfd-400 volt electrolytic capacitor which was connected to run a 180 volt DC generator/motor. Performance values were taken comparing other inductor core materials to iron such as high frequency ferrite materials. It is also anticipated that other enhanced materials which possesses high mechanical resonance properties may be added in future embodiments of the present invention without departing from the spirit and scope of the present invention.

### D. Other Test and Examples

The utility of this device which produces electrical current and voltage by the vibration of an electrical motor is as follows. First, we are able to generate electrical energy from an electrical generator/motor without direct electrical input or any mechanical force rotating the motor shaft, other than through vibration of the motor on a platform or other means of providing resonant vibrations to the motor. Second, we are able to generate mechanical forces plus the electrical energy, wherein the electrical energy output is actually transferred when a mechanical load is placed on the motor. Third, we are able to include mostly passive electrical components to regulate a predictable quantity of electrical energy and mechanical energy output, with enough energy returned to the system to reduce the amount of energy required to continually operate the system to near minimum. Fourth, we are able to create a useful power source to operate multiple apparatuses which require extremely high voltage at low current with a minimum amount of input energy. Other useful benefits can be achieved using the basic physical and mechanical implications found within the scope of this disclosed operational system and relevant subject matter which are previously unknown and had not been discovered until such time as the disclosure of the present invention.

Our other examples of this unique form of vibrational energy are disclosed in the following chart showing our tests of four similar but different DC motors. Three of our tested motors were 1.5 HP, DC motors but with different rated voltages from one another. Their rated voltages were 90 volts, 180 volts, and 450 volts. The motors had identical armatures, stator housings and outside dimensions as they came from the same manufacturer. Our forth motor was a 180 volt DC motor; however its rated horsepower was only 0.33 HP.

We performed two sets of tests. Each test had two parts to the test. Part 1 of each test used an inductor in the circuit and part 2 removed the inductor from the circuit. We used an AC watt meter to measure power drawn from the AC power source.

Our first test measured the output voltage from each tested motor to a 5 KV electrostatic volt meter with a 6,000 volt @ 0.015 Mf capacitor connected to its terminals. A string of high voltage diodes were connected to and from the positive and negative terminals of the motor to the volt meter with a wire running from negative terminal of the volt meter back to the terminal of the transducer located between the piezo discs of the transducer horn.

Our second tests ran a string of diodes connecting the positive and negative terminals of our motor as seen in the schematic diagram of FIG. 2. Our tests were made with the inductor shown in the diagram as well as the inductor removed from the circuit. The results of our tests are shown in the table shown below.

TABLE 1
Test Examples

| Test | Inductor | Motor Size | | Motor Size | | Motor Size | | Motor Size | |
|---|---|---|---|---|---|---|---|---|---|
| 40 KHz | | 90 | Volt | 180 | Volt | 450 | Volt | 180 | Volt |
| Transducer | | 1.5 | HP | 1.5 | HP | 1.5 | HP | .33 | HP |
| Measured | | | | | | | | | |
| Electrostatic | | | | | | | | | |
| Meter | | | | | | | | | |
| Voltage | | | | | | | | | |
| Power | Yes | 49.4 | Watts | 48 | Watts | 49.3 | Watts | 49 | Watts |
| Drawn | | | | | | | | | |
| | No | 48.8 | Watts | 48.3 | Watts | 49.2 | Watts | 51 | Watts |
| Voltage | Yes | 4650 | Volts | 4300 | Volts | 4500 | Volts | 4400 | Volts |
| Measured | | | | | | | | | |
| | No | 4250 | Volts | 4150 | Volts | 4100 | Volts | 3950 | Volts |
| Running | Measured at | | | | | | | | |
| voltage | Motor | | | | | | | | |
| | terminals | | | | | | | | |

| | | | | | | | | |
|---|---|---|---|---|---|---|---|---|
| Power | Yes | Does Not | 33 | Watts | 33 | Watts | 47 | Watts |
| Drawn | | Run | | | | | | |
| | No | Does Not | 50 | Watts | 49.9 | Watts | 48 | Watts |
| | | Run | | | | | | |
| Running | Yes | Does Not | 81 | Volts | 87 | Volts | 75 | Volts |
| Voltage | | Run | | | | | | |
| | No | Does Not | 93 | Volts | 105 | Volts | 53.5 | Volts |
| | | Run | | | | | | |

The preceding Table 1 shows that the measured resonant voltages between the various motor sizes and their voltage ratings were relatively the same. The 0.33 HP motor rated at 180 volts had a higher voltage reading with the inductor than the 1.5 HP motor rated at 180 volts. Our test has caused us to believe that the voltage increases with the amplitude of the signal from the transducer while the amperage increases with the increased mass and size of the ferrite armature which is in the electro-resonant circuit of the transducer.

Although the various embodiments of the invention have been described and shown above, it will be appreciated by those skilled in the art that numerous modifications may be made therein without departing from the scope of the invention as herein described.

### V. DETAILED DESCRIPTION OF THE DRAWINGS

FIG. 1 is a schematic view of the 100 watt @ 40 KHz driver board 12 which was used in our preliminary test. A power source such as a battery 10 is used to power the driver board 12. The driver board 12 is composed of common electrical components such as diodes, resistors, capacitors, transistors, inductors, and transformers as shown in the schematic view. The driver board output is connected to a transducer 14 which delivers electro-mechanical energy to the work piece.

FIG. 2 is a schematic view of our generator/motor driver configuration. A perspective view of the transducer 14 is shown in the drawing. The driver board 12 is shown powered by a battery 10. The driver board symbols + and − represent the connection points of the driver board to the transducer 14. The horn of the transducer 14 is secured to the underside of an electrically conductive surface 22, defining an electro-acoustical plate conducting electro-mechanical energy directly to a singular generator/motor 20, resting atop the electrically conductive surface 22 as seen in the schematic. The driver board 12 discloses a minus (−) output side that is connected to the junction of the piezo elements of transducer 14. An electrical circuit running from the junction of the piezo elements of transducer 14 travels through a tuned inductor 16 to a junction 28 between two diodes 24a and 24b. The diode 24a is connected to the positive terminal of generator/motor 20 and the diode 24b is connected to the negative terminal of generator/motor 20 forming a closed circuit between the terminals of the generator/motor 20. When the transducer 14 is turned on, the generator/motor 20 runs itself under this configuration. The direction of the motor rotation is determined by diode direction connecting the positive and negative motor terminals. If the direction of the diode configuration is reversed between the motor positive and negative terminals, the shaft rotation will reverse relative to facing the brush assembly.

FIG. 3 is a schematic view of a dual generator/motor driver configuration. A perspective view of the transducer 14 is shown in this drawing. The driver board 12 is shown powered by a battery 10. The driver board symbols + and − represent the connection points of the driver board to the transducer 14. The horn of the transducer 14 is secured to the base of an electrically conductive surface 22 which conducts electro-mechanical energy directly to the generator/motor 20 seen in the schematic. The driver board 12 discloses a minus (−) output side that is connected to the junction of the piezo elements of transducer 14. An electrical circuit running from the junction of the piezo elements of transducer 14 travels through a tuned inductor 16 to a series junction 28 between two capacitors 26a and 26b. The negative terminal of capacitor 26a is connected to the diode 24a facing the positive terminal of the generator/motor 20. The positive terminal of capacitor 26b is connected to the diode 24b facing away from the negative terminal of the generator/motor 20. A positive terminal of a motor 30 is connected to the positive terminal of capacitor 26h and a negative terminal of motor 30 is connected to the negative terminal of capacitor 26a. As the transducer 14 sends electro-mechanical energy through the base plate 22 to the driver generator/motor 20, a high voltage AC current is generated and is rectified to pass through diodes 24a and 24b to charge capacitors 26a and 26b. As the generator/motor 20 experiences the electrical load of charging capacitors 26a and 26b, it begins to rotate as a motor. As the voltage increases on capacitors 26a and 26b, the motor 30 begins to rotate from the power received from capacitors 26a and 26b. It should be noted that if a mechanical load is placed upon the drive shaft of motor 30, the increased electrical load experienced by the generator/motor 20 will cause an increase in the RPM drive shaft velocity of the generator/motor 20.

FIG. 4 is a schematic view of a dual generator/motor driver configuration which is similar to the schematic view seen in FIG. 3. A perspective view of the transducer 14 is shown in this drawing. The driver board 12 is shown powered by a battery 10. The driver board symbols + and − represent the connection points of the driver board to the transducer 14. The horn of the transducer 14 is secured to the base of an electrically conductive surface 22 which conducts electro-mechanical energy directly to the generator/motor 20 seen in the schematic. The driver board 12 discloses a minus (−) output side that is connected to the junction of the piezo elements of transducer 14. An electrical circuit running from the junction of the piezo elements of transducer 14 travels through a tuned inductor 16 to a series junction 28 between two capacitors 26a and 26b. The negative terminal of capacitor 26a is connected to the negative side of the fill wave bridge rectifier 32 which is connected to receive the high frequency AC output of the generator/motor 20. The positive terminal of capacitor 26b is connected to the positive side of the full wave bridge rectifier 32 which is connected to receive the high frequency AC output of the generator/motor 20. A positive terminal of the motor 30 is connected to the positive terminal of capacitor 26b and a negative terminal of the motor 30 is connected to the negative terminal of capacitor 26a. As the transducer 14 sends electro-mechanical energy through the base plate 22 to the generator/motor 20, a high voltage AC current is generated and is rectified to pass through the full wave bridge rectifier 32 to charge capacitors 26a and 26b. As the voltage increases on capacitors 26a and 26b, the motor 30 begins to rotate from the power received from capacitors 26a and 26b. The use of the full wave rectifier 32 prohibits the generator/motor 20 from rotating.

FIG. 5 is a perspective view of generator/motor 20 mounted on top of an electrically conductive plate 22. A transducer 14 is bolted to the electrically conductive plate 22 to transfer electromechanical energy to the generator/motor 20 when the transducer 14 is operational.

FIG. 6 discloses a dual wound armature 36 with two commutators 38a and 38b. The windings of commutator 38a and 38b are electrically isolated from one another. Commutator 38a is provided with two diodes 40a and 42a. Diode 40a faces toward the positive terminal of commutator 38a and diode 42a faces away from the negative terminal of commutator 38a. Commutator 38b is provided with two diodes 40b and 42b. Diode 40b faces toward the negative terminal of commutator 38b and diode 42b faces away from the positive terminal of commutator 38b. Diode 40a and 40b are connected in parallel to the negative terminal of battery 10. Diode 42a and 42b are connected in parallel to the positive terminal to battery 10. When a generator/motor containing the armature 36 receives electro-mechanical energy, the armature will rotate in a counter clockwise rotation when facing commutator 38a and a clockwise rotation when facing commutator 38b. The advantage of using a dual commutator armature 36 is that both sides of the resonant wave form will be utilized to produce constant torque on armature 36 while providing more energy to charge battery 10 while it is powering circuit board 12.

FIG. 7 discloses an external schematic view of the power loop disclosure provided in FIG. 6. A battery 10 provides power to the driver board 12, which sends output voltage to transducer 14, which is secured to the electrically conductive surface 22. Electro-acoustical energy is transferred from the horn of transducer 14 through the electrically conductive surface 22 to a dual wound/dual commutator generator/motor (dw/dc motor) 50, when the transducer 14 is powered and operational. Diodes 40a and 40b are connected to and facing away from the negative terminal of battery 10 and they are connected to the respective commutators and their terminals described in FIG. 6. Diodes 42a and 42b are connected to and facing toward the positive terminal of battery 10 and they are connected to the respective commutators and their terminals described in FIG. 6. An electrical circuit 52 is provided to deliver electro-mechanical resonant energy between the junction of the piezo elements of transducer 14 and a junction between two capacitors connected in series (C1) 54 and (C2) 56. The external terminal of capacitor (C1) 54 is connected to the positive terminal of battery 10 and the external terminal of capacitor (C2) 56 is connected to the negative terminal of battery 10. The electro-mechanical resonant energy which is transferred from the junction of the piezo elements of transducer 14 to the series junction between the two capacitors (C1) 54 and (C2) 56 transfers the electro-mechanical energy to the armature windings of the dw/dc generator/motor 50. When the dc/dw generator/motor 50 receives electro-acoustical energy from the horn of transducer 14 and electro-mechanical energy from the junction of the piezo elements of transducer 14 to the armature windings, it will charge the battery 10 which provides electrical power to the driver board 12 that powers the transducer 14. The energy loop seen in FIG. 7 discloses that the battery 10 and driver board 12 seen on the bottom of the schematic are the same battery 10 and driver hoard 12 seen at the top of the schematic. The dw/dc generator/motor 50 will rotate without a prime mover attached to it, while it is charging the battery 10. The overall system efficiency is determined by a number of factors including resonant frequency of transducer 14, signal amplitude and output rating of circuit board 12, and the size and dimensions of length to diameter ratio of the dw/dc generator/motor 50.

FIG. 8 discloses a pair of transducers 14a and 14b. Transducer 14a has a pair of piezo elements whose negative polarities are facing one another and whose positive polarities are facing outward toward the frontal horn and rear base. Transducer 14b has a pair of piezo elements whose positive polarities are facing one another and whose negative polarities are facing outward toward the frontal horn and rear base. The transducers 14a and 14b are paired up and connected in parallel to one another with an electrically suitable alternating current source be utilized in a push-pull configuration to form an electro-mechanical circuit.

FIG. 9 discloses a detailed schematic and perspective view of the brief disclosure provided in FIG. 8. Transducers 14a and 14b are secured to opposite ends of a permanent magnet DC generator/motor 50. The point of contact between transducers 14a and 14b and the generator/motor 50 is electrically conductive. Circuit board 12 provides a suitable alternating current source to transducers 14a and 14b which are connected in a parallel circuit configuration to the alternating electrical outputs of circuit board 12. The circuit 48a connects to the horn of transducer 14a and the circuit 48b connects to the horn of transducer 14b and they share the same electrical output terminal of circuit board 12. The circuit 46a which is connected to the junction of the piezo elements of transducer 14a and the circuit 46b which is connected to the junction of the piezo elements of transducer 14b share the same electrical output terminal of circuit board 12. A balancing transformer (balun) 44 is connected serially in the electrical circuit to the output terminal of circuit board 12 and the parallel circuits leading to transducers 14a and 14b. Transducers 14a and 14b are configured to operate mechanically 180 degrees out of phase from one another. When transducer 14a is in its longitudinal expansion phase, transducer 14b is in its longitudinal contraction phase and vice versa. The amplification of electro-mechanical resonance along a parallel path of the armature shaft of the generator/motor 50 is obtained when transducers 14a and 14b are operational and their resonant frequency is matched with the resonant frequency of generator/motor 50. As such, the matched resonant frequencies of transducers 14a and 14b with the resonant frequency of the generator/motor 50 provides an extremely efficient electrical power system.

I claim:

1. An apparatus for the production of electrical current and voltage by a tuned and selected vibration comprising:
a battery attaching to a driver board providing power to a transducer attaching below an electrically conductive surface conducting electro-mechanical energy produced by a vibration of said electrically conductive surface by said transducer;
a first generator/motor at a tuned frequency placed upon said electrically conductive surface causing said first generator/motor to operate by said vibration, converting said electro-mechanical energy from said vibration into operation of said first generator/motor, producing said electrical current and voltage to a positive and negative terminal of said first generator/motor upon commencement of operation of said transducer;
a plurality of diodes forming a diode bridge, each of said plurality of diodes respectively attached to said positive and negative terminals attached within circuit wiring between said positive and negative terminals of said first generator/motor, with additional circuit wiring between at least two of said plurality of diodes defining a junction; and
a tuned inductor within circuit wiring between said junction and said transducer and said driver board, wherein said vibration generates said current and voltage from said first generator/motor through said plurality of diodes, returning said current and voltage to said transducer and said driver board to sustain operation of said apparatus and thus sustain operation of said apparatus subsequent to commencement of said operation of said apparatus.

2. The apparatus of claim 1 wherein said driver board is defined as a pre-determined power and frequency driver board comprised of common electrical components including diodes, resistors, capacitors, transistors, inductors and transformers as generally shown in the circuit diagram of FIG. 1.

3. The apparatus of claim 1 wherein said first generator motor is a ferromagnetic electric permanent magnet DC generator/motor.

4. The apparatus of claim 1 further comprising:
said plurality of diodes extend additional circuit wiring to one or more second generator/motors producing additional electrical current and voltage, each said second generator/motor defining a ferromagnetic electric permanent magnet DC generator motor; and
between each of said plurality of diodes and said one or more second generator/motor is attached circuit wiring including a first capacitor and a second capacitor, with a negative terminal of said first capacitor connected to one of said plurality of diodes facing toward said positive terminal of said first generator/motor and a positive terminal of said second capacitor connected to one of said plurality of diodes facing away from said negative terminal of said first generator/motor with said circuit wiring between said first and second capacitor defining said junction; and
a tuned inductor within circuit wiring between said junction and said transducer and said driver board, wherein said vibration generates said current and voltage from said first generator/motor through said plurality of diodes and said first and second capacitors to said second generator/motors to generate additional electrical current and voltage while also returning said current and voltage to said transducer and said driver board to sustain operation of said apparatus and thus sustain operation of said apparatus subsequent to commencement of said operation of said apparatus.

5. The apparatus of claim 1, further comprising:
said positive and negative terminal of said first generator/motor are attached by an electrical circuit to a full wave bridge rectifier;
a first capacitor defines a negative terminal connected to a negative side of said full wave bridge rectifier which is further connected to a negative side of at least one second generator/motor and a second capacitor defines a positive terminal attached by an electrical circuit to a positive side of said full wave bridge rectifier which is further connected to a positive side of said at least one second generator/motor, said first and second capacitors capable of receiving a high frequency AC output of said first generator/motor;
an electrical circuit between said first and second capacitor defines a junction which extends an electrical circuit including a tuned inductor which transfers electrical current and voltage back to said transducer and said circuit board; and
a negative side of said first capacitor is attached to said negative terminal of said at least one second generator/motor with a positive side of said first capacitor directed towards said junction and a positive side of said second capacitor is attached to said negative terminal of said at least one second generator/motor with a negative side of said second capacitor directed towards said junction, wherein said vibration generates said current and voltage from said first generator/motor through said full wave bridge rectifier and said first and second capacitors to said at least one second generator/motor to generate additional electrical current and voltage while also returning said current and voltage to said transducer and said driver board to sustain operation of said apparatus and thus sustain operation of said apparatus subsequent to commencement of said operation of said apparatus.

6. The apparatus of claim 1 further comprising any other element as shown and disclosed in the specification and in the drawing figures.

7. The method and process for the production of electrical current and voltage by the vibration of an electrical generator/motor as disclosed the apparatus of claim 1.

8. An apparatus for the production of electrical current and voltage by a tuned and selected vibration comprising:
a battery defining a positive terminal and a negative terminal attaching to a driver board providing power to a transducer attaching below an electrically conductive surface conducting electro-mechanical energy produced by a vibration of said electrically conductive surface by said transducer;
a generator/motor, defining a dual wound, dual commutator, at a tuned frequency, placed upon said electrically conductive surface causing said generator/motor to operate by said vibration, converting said electro-mechanical energy from said vibration into operation of said generator/motor, producing said electrical current and voltage to positive and negative terminals of said generator/motor upon commencement of operation of said transducer;
a plurality of diodes connected by electrical circuitry to and facing away from said negative terminal of said battery and are connected to commutator terminals upon a first and second commutator further attaching by common electrical circuitry to an external terminal of a first capacitor;
a plurality of diodes connected by electrical circuitry to and facing said positive terminal of said battery and are connected to commutator terminals upon a first and second commutator further attaching by common electrical circuitry to an external terminal of a second capacitor, with said first and second capacitors attached to one another at a common junction; and
a circuit wiring between said junction and said transducer and said driver board, wherein said vibration generates said current and voltage from said generator/motor through said plurality of diodes, returning said current and voltage to said transducer and said driver board to sustain operation of said apparatus and thus sustain operation of said apparatus subsequent to commencement of said operation of said apparatus and further wherein said dual wound armature of said generator/motor receives electro-mechanical energy, said dual wound armature will rotate in a counter clockwise rotation when facing said first commutator and a clockwise rotation when facing said second commutator providing an advantage of utilizing both side of a resonant wave form to produce a constant torque on said dual armature while providing greater energy to charge said battery while powering said circuit board.

9. The apparatus of claim 8 wherein said driver board is defined as a predetermined power and frequency driver board comprised of common electrical components including diodes, resistors, capacitors, transistors, inductors and transformers as generally shown in the circuit diagram of FIG. 1.

10. The apparatus of claim 8 further comprising any other element as shown and disclosed in the specification and in the drawing figures.

11. A method and process for the production of electrical current and voltage by the vibration of an electrical generator/motor as disclosed within the apparatus of claim 8.

12. An apparatus for the production of electrical current and voltage by a tuned and selected vibration comprising:
an AC powered circuit board providing alternating electrical outputs;
a pair of first and second facing piezo element transducers which are paired up and connected in parallel to one another with an electrically tuned alternating current supplied by said alternating electrical output of said AC powered circuit board in a push-pull configuration to form an electro-mechanical energy circuit, with a balancing transformer connected serially in the electrical circuitry between said AC powered circuit board;
a permanent magnet DC generator/motor receiving said electro-mechanical energy circuit with said pair of transducers operating mechanically 180 degrees out of phase from one another creating said push-pull configuration, wherein said first transducer is in a longitudinal expansion phase, said second transducer is in a longitudinal contraction phase, and vice versa thus providing said generator/motor operation creating amplification of electrical output from rotation of said generator/motor upon the matching of resonant frequency of said paired transducers with a resonant frequency of said generator/motor, providing an efficient electrical power system.

13. The apparatus of claim 12 further comprising any other element as shown and disclosed in the specification and in the drawing figures.

14. A method and process for the production of electrical current and voltage by the vibration of an electrical generator/motor as disclosed within the apparatus of claim 12.
